(19) United States
(12) Patent Application Publication
(10) Pub. No.: US 2026/0302247 A1
(43) Pub. Date: Oct. 1, 2026

(54) MANUFACTURING METHOD FOR ELECTRODE, ELECTRODE, AND USE THEREOF

(71) Applicant: Prime Planet Energy & Solutions, Inc., Tokyo (JP)

(72) Inventor: Taisuke ISEDA, Kobe-shi (JP)

(21) Appl. No.: 19/578,888

(22) Filed: Mar. 26, 2026

(30) Foreign Application Priority Data
Mar. 31, 2025 (JP) 2025-058809

(51) Int. Cl. H01M 4/62; H01M 4/02; H01M 4/04; H01M 4/139; H01M 4/80

(52) U.S. Cl. CPC H01M 4/626; H01M 4/0404; H01M 4/0471; H01M 4/139; H01M 4/623; H01M 4/80; H01M 2004/021; H01M 2004/028

(57) ABSTRACT

Provided is a technique of suppressing the decrease in conductivity of an electrode. According to the technique disclosed herein, a manufacturing method for an electrode including an electrode active material layer, and a current collection layer on a surface of the electrode active material layer is disclosed. This manufacturing method includes providing the electrode active material layer on a surface of a base material, applying a slurry including a first metal powder with an average particle diameter of less than 100 nm on the surface of the electrode active material layer on the base material, and performing heat processing on the electrode active material layer and the slurry applied on the surface of the electrode active material layer at a temperature lower than a thermal decomposition temperature of a resin binder, thereby providing the current collection layer on the surface of the electrode active material layer.

### CROSS REFERENCE TO RELATED APPLICATIONS

The present application claims the priority based on Japanese Patent Application No. 2025-058809 filed on Mar. 31, 2025, the entire contents of which are incorporated in the present specification by reference.

### BACKGROUND OF THE DISCLOSURE

### 1. Technical Field

The present disclosure relates to a manufacturing method for an electrode, an electrode, and use thereof.

### 2. Background

As an energy storage device including an electrode, a secondary battery such as a lithium ion secondary battery is given. In recent years, this kind of energy storage device has been suitably used for driving power sources of vehicles such as a battery electric vehicle (BEV), a hybrid electric vehicle (HEV), and a plug-in hybrid vehicle (PHEV), and the like, for example.

Japanese Patent Application Publication No. 2010-170972 discloses a positive electrode member used for a nonaqueous electrolyte battery including a positive electrode, a negative electrode, and a nonaqueous electrolyte layer disposed between these electrodes. This positive electrode member includes a first active material layer including a positive electrode active material, a second active material layer including the positive electrode active material and disposed facing the first active material layer, and a positive electrode current collection layer disposed between the first active material layer and the second active material layer. The first active material layer, the second active material layer, and the positive electrode current collection layer are integrated by sintering. According to Japanese Patent Application Publication No. 2010-170972, this structure makes it possible to manufacture a high-capacity nonaqueous electrolyte battery.

Japanese Patent Application Publication No. 2015-220107 discloses an all-solid lithium ion secondary battery including a battery element including an electrolyte layer between a positive electrode layer and a negative electrode layer, and an electrode at an end part of the battery element. The battery element is covered with a water vapor barrier layer formed of an inorganic material with a thickness of 5 to 1000 nm. According to Japanese Patent Application Publication No. 2015-220107, this structure makes it possible to suppress a reaction between a water-proof layer and an element material of the all-solid lithium ion secondary battery and to suppress the influence of water vapor in the all-solid lithium ion secondary battery that can be surface-mounted on a printed board.

Japanese Patent Application Publication No. 2019-164957 discloses an energy storage component including a base material having a main surface with an insulating property, a positive electrode active material layer formed on the main surface, a negative electrode active material layer formed on the main surface and facing the positive electrode active material layer, a positive electrode current collector layer formed on the main surface and being adjacent to the positive electrode active material layer, and a negative electrode current collector layer formed on the main surface and being adjacent to the negative electrode active material layer. According to Japanese Patent Application Publication No. 2019-164957, this structure makes it possible to reduce the thickness of the electrodes.

### SUMMARY

The present inventor considers to suppress the decrease in conductivity regarding an electrode including an electrode active material layer and a current collection layer provided on a surface of the electrode active material layer.

According to the art disclosed herein, a manufacturing method for an electrode including an electrode active material layer containing an electrode active material and a resin binder, and a current collection layer provided on a surface of the electrode active material layer is disclosed. This manufacturing method includes providing the electrode active material layer on a surface of a base material, applying a slurry including a first metal powder with an average particle diameter of less than 100 nm based on a dynamic light scattering method on the surface of the electrode active material layer provided on the base material, and performing heat processing on the electrode active material layer and the slurry applied on the surface of the electrode active material layer at a temperature lower than a thermal decomposition temperature of the resin binder, thereby providing the current collection layer on the surface of the electrode active material layer. With such a structure, the decrease in conductivity of the electrode can be suppressed.

In another aspect of the art disclosed herein, a manufacturing method for an energy storage device including an electrode is disclosed. This manufacturing method includes manufacturing the electrode using the manufacturing method for the electrode described above. With such a structure, the decrease in conductivity of the electrode can be suppressed. Accordingly, the decrease in performance of the energy storage device can be suppressed.

In another aspect of the art disclosed herein, an electrode including an electrode active material layer containing an electrode active material and a resin binder, and a current collection layer provided on a surface of the electrode active material layer is disclosed. The current collection layer includes metal particles with an average particle diameter of 100 nm to 10 μm based on an electron microscope observation image of a cross section along a thickness direction of the electrode active material layer, and a metal bond part connecting between the metal particles. With such a structure, the decrease in conductivity of the electrode can be suppressed.

In another aspect of the art disclosed herein, an energy storage device including the electrode described above is disclosed. With such a structure, the decrease in conductivity of the electrode can be suppressed. Accordingly, the decrease in performance of the energy storage device can be suppressed.

### BRIEF DESCRIPTION OF THE DRAWINGS

FIG. 1 is a flowchart of a manufacturing method;

FIG. 2 is a cross-sectional view of a base material S and a positive electrode 32;

FIG. 3 is a plan view of a positive electrode active material layer 32a and a positive electrode current collection layer 32b;

FIG. 4 is a perspective view of an energy storage device 1;

FIG. 5 is a perspective view of the energy storage device 1;

FIG. 6 is a cross-sectional view taken along VI-VI in FIG. 4;

FIG. 7 is a schematic cross-sectional view of an electrode assembly 30; and

FIG. 8 is a cross-sectional view of a positive electrode 232.

### DESCRIPTION OF THE EMBODIMENTS

One embodiment of an energy storage device disclosed herein will hereinafter be described. The embodiment to be described here will not limit the art disclosed herein in particular. The art disclosed herein is not limited to the embodiment to be described here unless specific statement is made. The drawings are illustrated schematically and do not necessarily reflect the actual objects. The members and parts with the same operation are denoted by the same reference sign as appropriate and the overlapping description may be omitted. In the drawings, reference signs “X”, “Y”, and “Z” respectively denote “a first direction”, “a second direction”, and “a third direction” in this specification. In the drawings, reference signs “X1”, “X2”, “Y1”, “Y2”, “Z1”, and “Z2” respectively denote directions in the drawings. However, these are merely directions determined for convenience of description and do not limit the mode of installation of the energy storage device. The notation “A to B” for a numerical range signifies a value “more than or equal to A and less than or equal to B”, and encompasses also the meaning of being “more than A and less than B” unless specific statement is made.

In this specification, the term “energy storage device” refers to a device that is charged and discharged by transfer of charge carriers between a pair of electrodes (a positive electrode and a negative electrode) through an electrolyte. Such energy storage devices encompass secondary batteries such as lithium ion secondary batteries, nickel-hydrogen batteries, and nickel-cadmium batteries. The energy storage device may be, for example, a lithium ion secondary battery.

### First Embodiment

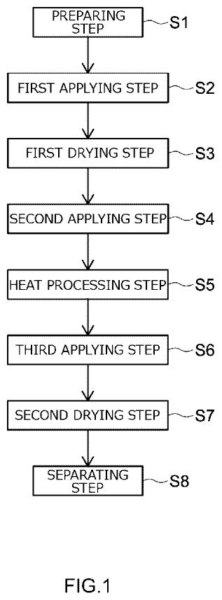

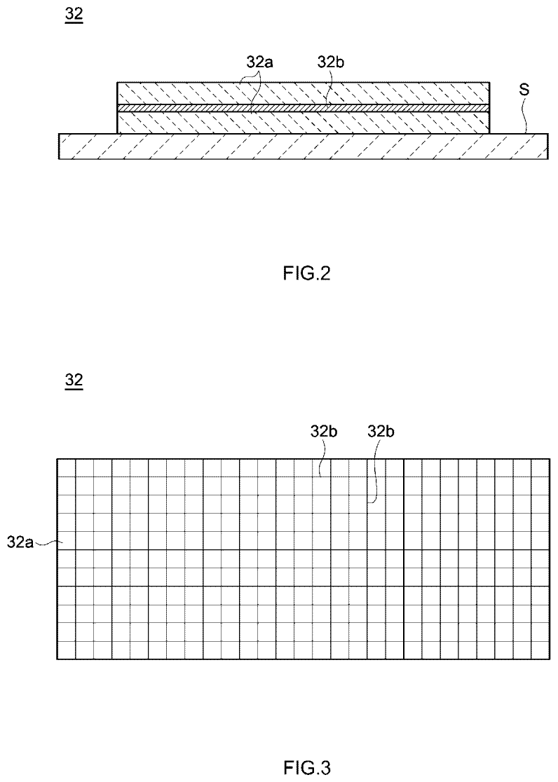

FIG. 1 is a flowchart of a manufacturing method. In FIG. 1, the flowchart of the manufacturing method for an electrode according to one embodiment is shown. FIG. 2 is a cross-sectional view of a base material S and a positive electrode 32. In FIG. 2, a cross-sectional structure of the positive electrode 32 provided on a surface of the base material S taken along a thickness direction of the positive electrode 32 is schematically shown. Note that, in this embodiment, “the thickness direction of the positive electrode 32” refers to a stacking direction of a positive electrode active material layer 32a and a positive electrode current collection layer 32b. As one example of the manufacturing method for an electrode disclosed herein, a manufacturing method for the positive electrode 32 will be described below with reference to FIG. 1 and FIG. 2 as appropriate. The positive electrode 32 is a positive electrode of a lithium ion secondary battery in the following description, although there is no particular limitation.

As shown in FIG. 1, the manufacturing method includes a preparing step S1, a first applying step S2, a first drying step S3, a second applying step S4, a heat processing step S5, a third applying step S6, a second drying step S7, and a separating step S8.

In the preparing step S1, for example, a first slurry and a second slurry are prepared. The first slurry here is an active material layer formation slurry, and includes a material for forming the positive electrode active material layer 32a. The first slurry includes, for example, a positive electrode active material, a resin binder, a conductive material, and a solvent.

As the positive electrode active material, for example, various positive electrode active materials used for the lithium ion secondary battery can be used without particular limitations. The positive electrode active material may be, for example, a lithium complex oxide, a lithium transition metal phosphate compound, or the like. A crystal structure of the positive electrode active material is not limited in particular and may be a layered structure, a spinel structure, an olivin structure, or the like. One kind of the positive electrode active material may be included alone, or two or more kinds thereof may be included.

As the lithium complex oxide, a lithium transition metal complex oxide containing at least one among Ni, Co, and Mn as a transition metal element is preferable. Preferred examples thereof include lithium nickel complex oxides, lithium cobalt complex oxides, lithium manganese complex oxides, lithium nickel manganese complex oxides, lithium nickel cobalt manganese complex oxides, lithium nickel cobalt aluminum complex oxides, lithium iron nickel manganese complex oxides, and the like.

Note that, in this specification, the term “lithium nickel cobalt manganese complex oxides” encompasses, in addition to an oxide containing Li, Ni, Co, Mn, and O as the constituent elements, an oxide containing one kind, or two or more kinds of additive elements in addition to those above. Examples of the additive elements include transition metal elements and typical metal elements, such as Mg, Ca, Al, Ti, V, Cr, Y, Zr, Nb, Mo, Hf, Ta, W, Na, Fe, Zn, and Sn. The additive element may be a semimetal element such as B, C, Si, or P or a nonmetal element such as S, F, Cl, Br, or I. This similarly applies to the lithium nickel complex oxide, the lithium cobalt complex oxides, the lithium manganese complex oxides, the lithium nickel manganese complex oxides, the lithium nickel cobalt aluminum complex oxides, the lithium iron nickel manganese complex oxides, and the like described above.

Examples of the lithium transition metal phosphate compound include lithium iron phosphate (LiFePO₄), lithium manganese phosphate (LiMnPO₄), lithium manganese iron phosphate, and the like.

Examples of the resin binder include polyvinylidene fluoride (PVdF), polytetrafluoroethylene (PTFE), styrene butadiene rubber (SBR), and the like. As the conductive material, for example, carbon black such as acetylene black (AB), carbon fiber such as vapor grown carbon fiber (VGCF) or carbon nanotubes (CNTs), other carbon materials such as graphite, or the like may be used. As the solvent, for example, N-methyl pyrrolidone may be used.

When the entire solid component of the first slurry is 100 mass %, the content ratio of the positive electrode active material is for example 80 mass % to 99.5 mass %, and preferably 90 mass % to 99 mass %. When the entire solid component of the first slurry is 100 mass %, the content ratio of the conductive material is for example 0.1 mass % to 20 mass %, and preferably 0.3 mass % to 15 mass %. When the entire solid component of the first slurry is 100 mass %, the content ratio of the binder is for example 0.4 mass % to 15 mass %, and preferably 0.5 mass % to 10 mass %. The solid component of the first slurry here includes the positive electrode active material, the resin binder, the conductive material, other additives as necessary, and the like. When the entire first slurry is 100 mass %, the content ratio of the solid component is about 50 mass % to 90 mass %, and is set as appropriate in consideration of how easily the application and drying are performed, and so on.

The second slurry here is a current collection layer formation slurry, and includes a material for forming the positive electrode current collection layer 32b. The second slurry includes, for example, a first metal powder, a surfactant, and a solvent.

The first metal powder may be formed of, for example, metal that does not dissolve at a positive electrode potential when the energy storage device including the positive electrode 32 is used. Preferred examples of the first metal powder include a gold powder, a silver powder, an aluminum powder, and the like.

The first metal powder has an average particle diameter of less than 100 nm here. From the viewpoint of achieving the effect of the art disclosed herein more suitably, the average particle diameter of the first metal powder may be for example 1 nm to 90 nm, and is preferably 5 nm to 80 nm, more preferably 10 nm to 70 nm, still more preferably 15 nm to 60 nm, and particularly preferably 20 nm to 50 nm. Note that, in this specification, the average particle diameter of the first metal powder is an average particle diameter (DDLS) based on a dynamic light scattering method (DLS method). The average particle diameter (DDLS) based on the DLS method can be measured in accordance with JIS Z 8828:2013. In this measurement, for example, a commercial measurement device such as a measurement device “Zetasizer Nano ZS” manufactured by Malvern Panalytical can be used.

The shape of first metal particles constituting the first metal powder is not limited in particular, and may be, for example, a spherical shape, a plate-like shape, a columnar shape, a needle-like shape, a flake shape, or the like.

As the surfactant, surfactants that are used in this kind of application can be used without particular limitations. Preferred examples of the surfactant include acrylic acid polymer. For example, the acrylic aid polymer may be at least one polymer among acrylic acid monomer, methacryl acid monomer, acrylic acid ester monomer, and methacrylic acid ester monomer. As the solvent, solvents that are used in this kind of application can be used without particular limitations. As the solvent, for example, alcohols such as decanol and terpineol can be preferably used.

When the entire second slurry is 100 mass %, the content ratio of the first metal powder may be about 50 mass % to 90 mass %. In the second slurry, the content ratio of the surfactant and the content ratio of the solvent can be set as appropriate without particular limitations. Note that the second slurry may include an additive other than the aforementioned components and usable for this kind of application as appropriate as long as the effect of the art disclosed herein is not inhibited. As the additive, for example, the resin binder or the like is given. The resin binder may be, for example, the same as the resin binder included in the first slurry and may include celluloses such as ethyl cellulose and carboxymethyl cellulose, an epoxy resin, an acrylic resin, or the like.

A method of preparing the first slurry and the second slurry is not limited in particular and may be a conventionally known method. For example, the first slurry and the second slurry may be prepared by mixing the materials in a commercial mixing device or the like.

In the first applying step S2, for example, the first slurry is applied on a surface of the base material S. By performing the first applying step S2, for example, a coating film of the first slurry can be obtained on the base material S. A method of applying the first slurry is not limited in particular and a method that is used in this kind of application can be used as appropriate. The first slurry can be applied (by coating) on the surface of the base material S using, for example, a coating device such as a gravure coater, a coma coater, a slit coater, or a die coater. As the base material S, for example, a mold-release type base material that is used in this kind of application can be used without particular limitations. As the mold-release type base material, for example, a ceramic base material, a base material including a silicone resin, a fluorine resin, or the like on its surface, or the like is given.

In the first drying step S3, for example, the base material S and the first slurry applied on the base material S (here, the coating film of the first slurry) are subjected to a drying process. By performing the first drying step S3, for example, the solvent can be removed from the first slurry and the positive electrode active material layer 32a, which is a dry film of the first slurry, can be obtained on the base material S. The first drying step S3 may be performed by, for example, using a drying device such as a drying furnace. The drying temperature and drying time may be set as appropriate in accordance with the content ratio of the solid component of the first slurry, or the like. The drying temperature may be, for example, 60° C. to 200° C. (preferably 70° C. to 150° C.). The drying time may be, for example, 10 seconds to 30 minutes (preferably, 30 seconds to 10 minutes).

In the second applying step S4, for example, the second slurry is applied on a surface of the positive electrode active material layer 32a provided on the base material S after the first drying step S3. By performing the second applying step S4, for example, a coating film of the second slurry is obtained on the surface of the positive electrode active material layer 32a. A method of applying the second slurry is not limited in particular and the method that is used in this kind of application can be used as appropriate. In this embodiment, a printing method such as screen printing or ink-jet printing is preferably used. Alternatively, the second slurry may be printed in a predetermined pattern on a transfer sheet of paper and the second slurry may be transferred to the surface of the positive electrode active material layer 32a.

In this embodiment, the second slurry is applied (here, printed) into a mesh shape on the surface of the positive electrode active material layer 32a in the second applying step S4. Thus, after the heat processing step S5 to be described below, the positive electrode current collection layer 32b in the mesh shape in a plan view is obtained (see FIG. 3). FIG. 3 is a plan view of the positive electrode active material layer 32a and the positive electrode current collection layer 32b. In FIG. 3, the plan view in which the positive electrode active material layer 32a and the positive electrode current collection layer 32b after the heat processing step S5 to be described below are seen from above is shown.

In the heat processing step S5, for example, the positive electrode active material layer 32a and the second slurry applied on the surface of the positive electrode active material layer 32a are subjected to heat processing after the second applying step S4. By performing the heat processing step S5, for example, the solvent can be removed from the second slurry and the first metal particles can be sintered to each other; thus, the positive electrode current collection layer 32b, which is a sintered film of the second slurry, is obtained on the positive electrode active material layer 32a. The heat processing step S5 may be performed by using a heat processing device such as a sintering furnace, for example. The temperature of the heat processing and the time for the heat processing may be determined as appropriate in accordance with the content ratio of the solid component of the second slurry, the average particle diameter (size) of the first metal powder, the kind of the solvent included in the second slurry, the kind of the resin binder included in the positive electrode active material layer 32a, and the like. The temperature of the heat processing is lower than the thermal decomposition temperature of the resin binder included in the positive electrode active material layer 32a. From the viewpoint of preventing the thermal decomposition of the resin binder, the temperature of the heat processing is preferably 200° C. or less, more preferably 190° C. or less, and still more preferably 180° C. or less. In contrary, from the viewpoint of increasing the sintering property of the first metal powder, the temperature of the heat processing is for example 100° C. or more, preferably 110° C. or more, and more preferably 120° C. or more. The time for the heat processing is for example 15 minutes to 10 hours and preferably 30 minutes to 5 hours.

In the third applying step S6, for example, the first slurry is applied on a surface of the positive electrode current collection layer 32b after the heat processing step S5. By performing the third applying step S6, for example, the coating film of the first slurry is obtained on the positive electrode current collection layer 32b. The method of applying the first slurry may be the same as the method used in the first applying step S2.

In the second drying step S7, for example, the first slurry (here, the coating film of the first slurry) applied on the surface of the positive electrode current collection layer 32b is subjected to the drying process after the third applying step S6. By performing the second drying step S7, for example, the solvent can be removed from the first slurry and the positive electrode active material layer 32a, which is a dry film of the first slurry, can be obtained on the positive electrode current collection layer 32b. In addition, by performing this step, a multilayer body of the positive electrode active material layer 32a and the positive electrode current collection layer 32b is obtained on the base material S. The second drying step S7 may be performed by a method similar to the method used in the first drying step S3. The drying temperature and the drying time in this step may be the same as those in the first drying step S3.

In the separating step S8, for example, the multilayer body of the positive electrode active material layer 32a and the positive electrode current collection layer 32b is separated from the base material S after the second drying step S7. Thus, the positive electrode 32 is obtained.

One example of the manufacturing method for an electrode disclosed herein has been described above; however, the aforementioned steps may be omitted as appropriate or another step may be added as appropriate as long as the effect of the art disclosed herein is obtained. For example, the first drying step S3 and/or the second drying step S7 may be followed by a pressing step. By performing the pressing step, the positive electrode active material layer 32a can be compressed to a desired density and the dense filling of the positive electrode active material becomes possible. The pressing step can be performed using, for example, a conventionally known pressing device such as a roller press. In another example, the third applying step S6 and the second drying step S7 may be omitted as appropriate in accordance with the multilayer structure desired for the positive electrode 32.

The aforementioned manufacturing method is a manufacturing method for the positive electrode 32 including the positive electrode active material layer 32a containing the positive electrode active material and the resin binder, and the positive electrode current collection layer 32b provided on the surface of the positive electrode active material layer 32a. This manufacturing method includes: providing the positive electrode active material layer 32a on the surface of the base material S; applying the slurry (here, the second slurry) including the first metal powder with an average particle diameter of less than 100 nm based on the DLS method on the surface of the positive electrode active material layer 32a provided on the base material S; and performing the heat processing on the positive electrode active material layer 32a and the second slurry applied on the surface of the positive electrode active material layer 32a at the temperature lower than the thermal decomposition temperature of the resin binder, thereby providing the positive electrode current collection layer 32b on the surface of the positive electrode active material layer 32a.

In other words, in this manufacturing method, the positive electrode active material layer 32a is provided on the surface of the base material S, the second slurry including the first metal powder is applied on the surface of the positive electrode active material layer 32a, and the heat processing is performed additionally; thus, the positive electrode current collection layer 32b is provided on the surface of the positive electrode active material layer 32a. Here, the average particle diameter of the first metal powder used for forming the positive electrode current collection layer 32b is less than 100 nm. Thus, the sintering temperature between the first metal particles constituting the first metal powder can be reduced. Therefore, the heat processing for forming the positive electrode current collection layer 32b can be performed at the temperature lower than the thermal decomposition temperature of the resin binder included in the positive electrode active material layer 32a. Such heat processing makes it possible to suppress that the resin binder included in the positive electrode active material layer 32a is burned down. Accordingly, the decrease in bindability for the positive electrode active material in the positive electrode active material layer 32a can be suppressed and furthermore, the decrease in conductivity of the positive electrode 32 can be suppressed.

The temperature of the heat processing may be 200° C. or less. This makes it possible to more suitably reduce the risk that the resin binder included in the positive electrode active material layer 32a is thermally decomposed.

The resin binder included in the positive electrode active material layer 32a may be PVdF. This makes it possible to bind the positive electrode active material more suitably in the positive electrode active material layer 32a.

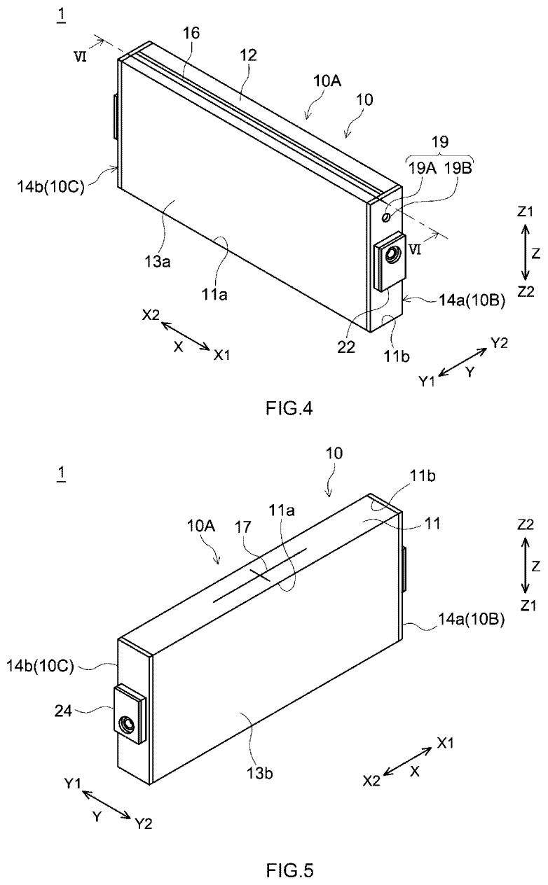

In the application of the second slurry, the second slurry may be applied in the mesh shape in the plan view on the surface of the positive electrode active material layer 32a. This makes it possible to further reduce the first metal powder used for forming the positive electrode current collection layer 32b. Thus, for example, the amount of heat generation at the occurrence of internal short-circuit can be reduced more. In addition, the size or weight of the energy storage device 1 (see FIG. 4, etc.) can be reduced more. Note that when the area of the entire surface of the positive electrode active material layer 32a where the positive electrode current collection layer 32b is provided is 100%, the area of the positive electrode current collection layer 32b may be about 10% to 90%. The thickness of the positive electrode current collection layer 32b is for example 0.5 μm to 20 μm, and preferably 1 μm to 10 μm.

As described above, the manufacturing method for an electrode disclosed herein may be the manufacturing method for the positive electrode 32. Thus, the positive electrode in which the decrease in conductivity is suppressed can be provided. Furthermore, the amount of metal required to form the current collection layer can be reduced compared to a conventional positive electrode including a current collection foil; thus, the positive electrode with higher safety can be provided and additionally, the energy storage device with the reduced size or weight can be achieved.

The first metal powder may be the gold powder or the silver powder. The gold powder and the silver powder are excellent in that they are easily handled, for example. Therefore, the productivity of the positive electrode 32 can be increased. Moreover, the gold powder and the silver powder are excellent in electric conductivity. Therefore, the conductivity in the positive electrode 32 can be increased.

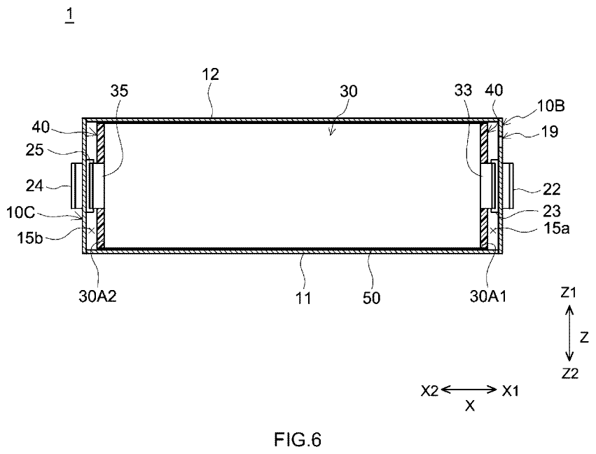

The manufacturing method for the positive electrode 32 described above may be included in the manufacturing method for the energy storage device 1 (see FIG. 4), for example. FIG. 4 and FIG. 5 are perspective views of the energy storage device 1. In FIG. 4, the energy storage device 1 when a Z1 side corresponds to an upper side in the drawing is shown. In FIG. 4, an upper surface 12 of the energy storage device 1 is disposed on the upper side in the drawing. In FIG. 5, the energy storage device 1 when a Z2 side corresponds to the upper side in the drawing is shown. In FIG. 5, a bottom surface 11 of the energy storage device 1 is disposed on the upper side in the drawing. FIG. 6 is a cross-sectional view taken along VI-VI in FIG. 4. In FIG. 6, a cross-sectional structure of the energy storage device 1 when a first side surface 13a (see FIG. 1) on one side is disposed on a front surface is shown.

As illustrated in FIG. 4 to FIG. 6, the energy storage device 1 includes a case 10, a positive electrode terminal 22, a negative electrode terminal 24, an electrode assembly 30, a spacer 40, a resin film 50, and an electrolyte solution (not shown). The energy storage device 1 is the lithium ion secondary battery here.

As illustrated in FIG. 4 to FIG. 6, the case 10 includes the bottom surface 11, the upper surface 12, a pair of first side surfaces 13a and 13b facing each other, and a pair of second side surfaces 14a and 14b facing each other. The case 10 has a hexahedron shape here. In this embodiment, the bottom surface 11 and the upper surface 12 have a rectangular shape and face each other. In the mode illustrated in FIG. 4 and FIG. 5, the pair of first side surfaces 13a and 13b facing each other extend from a pair of long sides 11a facing each other at the bottom surface 11, and have a relatively large area. The pair of second side surfaces 14a and 14b facing each other extend from a pair of short sides 11b facing each other at the bottom surface 11, and have a relatively small area.

As illustrated in FIG. 4 to FIG. 6, the case 10 includes a case main body 10A, a first sealing plate 10B, and a second sealing plate 10C. The case main body 10A has a rectangular tubular shape, for example, and includes the bottom surface 11, the upper surface 12, and the pair of first side surfaces 13a and 13b facing each other. In this embodiment, a part of the case main body 10A that is surrounded by the bottom surface 11, the upper surface 12, and the pair of first side surfaces 13a and 13b facing each other corresponds to an opening. As illustrated in FIG. 6, the energy storage device 1 includes two openings 15a and 15b.

For example, the case main body 10A can be manufactured by bending one metal plate into a tubular shape and bonding (for example, bonding by welding) a joint. Therefore, the case main body 10A includes a bonding part 16 extending along the first direction X on the upper surface 12 as illustrated in FIG. 4. The case main body 10A may be formed of a metal such as aluminum, an aluminum alloy, iron, or an iron alloy, for example, although there is no particular limitation.

As illustrated in FIG. 5, the case main body 10A includes a safe valve 17 at the bottom surface 11. The safe valve 17, for example, is a thin part that is designed to break when the pressure in the case 10 becomes a predetermined value so as to release the internal pressure. Note that the safe valve 17 is not necessarily provided at the bottom surface 11. In another embodiment, the safe valve 17 may be provided at the upper surface 12 or the first side surface 13a or 13b.

The first sealing plate 10B is, for example, a member that seals one opening 15a. The first sealing plate 10B is, for example, a plate-shaped member with a substantially rectangular shape. In this embodiment, the first sealing plate 10B is fitted to one opening 15a and bonded by welding (for example, laser welding). As illustrated in FIG. 4 and FIG. 6, the positive electrode terminal 22 is attached to the first sealing plate 10B.

In this embodiment, the first sealing plate 10B includes a liquid injection part 19. The liquid injection part 19 includes a liquid injection hole 19A and a sealing plug 19B. Here, the liquid injection hole 19A is a part to inject the electrolyte solution into the case 10 in a manufacturing process for the energy storage device 1. In this embodiment, the liquid injection hole 19A is provided closer to the upper surface 12 at the first sealing plate 10B. The sealing plug 19B here is a member that closes the liquid injection hole 19A.

The second sealing plate 10C is, for example, a member that seals the other opening 15b. The second sealing plate 10C is, for example, a plate-shaped member with a substantially rectangular shape. In this embodiment, the second sealing plate 10C is fitted to the other opening 15b and bonded by welding (for example, laser welding). As illustrated in FIG. 5 and FIG. 6, the negative electrode terminal 24 is attached to the second sealing plate 10C.

In the mode illustrated in FIG. 4 to FIG. 6, the first sealing plate 10B and the second sealing plate 10C form the pair of second side surfaces 14a and 14b facing each other. Both the first sealing plate 10B and the second sealing plate 10C are preferably formed of the same metal material as the metal material of the case main body 10A, for example.

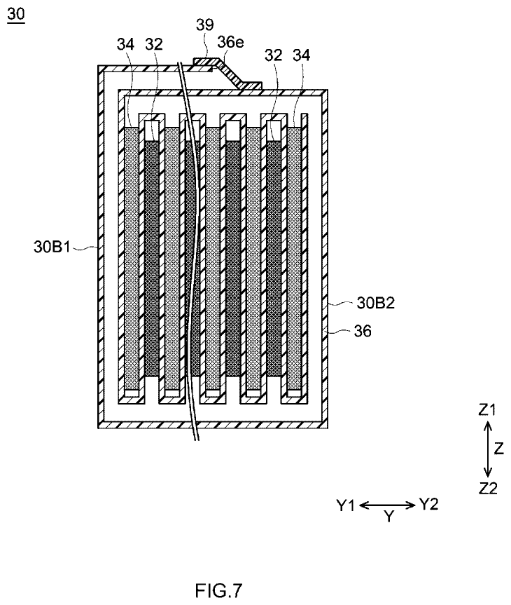

The positive electrode terminal 22 is electrically connected to the positive electrode 32 (see FIG. 7) of the electrode assembly 30, for example. As illustrated in FIG. 4 and FIG. 6, the positive electrode terminal 22 is attached to the first sealing plate 10B. As illustrated in FIG. 6, the positive electrode terminal 22 is electrically connected to a positive electrode tab 33 of the electrode assembly 30 through a positive electrode current collection part 23. The positive electrode terminal 22 is formed of a metal, for example, and is preferably formed of aluminum or an aluminum alloy. Note that the positive electrode terminal 22 may form the positive electrode current collection part 23.

The negative electrode terminal 24 is electrically connected to a negative electrode 34 (see FIG. 7) of the electrode assembly 30, for example. As illustrated in FIG. 5 and FIG. 6, the negative electrode terminal 24 is attached to the second sealing plate 10C. As illustrated in FIG. 6, the negative electrode terminal 24 is electrically connected to a negative electrode tab 35 of the electrode assembly 30 through a negative electrode current collection part 25. The negative electrode terminal 24 is formed of a metal, for example, and is preferably formed of copper or a copper alloy. Note that the negative electrode terminal 24 may form the negative electrode current collection part 25.

The electrode assembly 30 is, for example, an electric energy generation element in the energy storage device 1. As illustrated in FIG. 6, the electrode assembly 30 is accommodated in the case 10. FIG. 7 is a schematic cross-sectional view of the electrode assembly 30. In FIG. 7, a cross-sectional structure of the electrode assembly 30 seen from the first sealing plate 10B (see FIG. 6) side is schematically shown. The electrode assembly 30 has, for example, a flat shape. As illustrated in FIG. 6 and FIG. 7, the electrode assembly 30 includes a pair of first end surfaces 30A1 and 30A2 facing each other and a pair of second end surfaces 30B1 and 30B2 facing each other. In this embodiment, the first end surfaces 30A1 and 30A2 are stacked surfaces of the electrodes and a separator 36, and also open surfaces that open to the outside of the electrode assembly 30. As illustrated in FIG. 6, the first end surface 30A1 faces the first sealing plate 10B. The first end surface 30A2 faces the second sealing plate 10C. In this embodiment, the second end surfaces 30B1 and 30B2 are formed by the separator 36. Therefore, the separator 36 that forms the second end surfaces 30B1 and 30B2 forms an outer surface of the electrode assembly 30. The second end surfaces 30B1 and 30B2 here have a rectangular shape and face the first side surfaces 13a and 13b of the case 10.

In the mode illustrated in FIG. 6, the first end surface 30A1 on one side includes the positive electrode tab 33 connected to the positive electrode 32 of the electrode assembly 30. The first end surface 30A2 on the other side includes the negative electrode tab 35 connected to the negative electrode 34 of the electrode assembly 30. The positive electrode tab 33 is provided at each positive electrode 32 included in the electrode assembly 30 here. The positive electrode tabs 33 provided at the respective positive electrodes 32 (the positive electrode tabs 33) are overlapped on each other, for example, to form a positive electrode tab group. The negative electrode tab 35 is provided at each negative electrode 34 included in the electrode assembly 30, here. The negative electrode tabs 35 provided at the respective negative electrodes 34 (the negative electrode tabs 35) are overlapped on each other, for example, to form a negative electrode tab group.

As illustrated in FIG. 7, the electrode assembly 30 includes the positive electrode 32, the negative electrode 34, and the separator 36 existing between the positive electrode 32 and the negative electrode 34. In this embodiment, the electrode assembly 30 is an electrode assembly with a flat shape including a zigzag structure where the separator 36 with a long band-like shape is folded alternately at predetermined intervals so as to have a zigzag shape and the positive electrodes 32 and the negative electrodes 34 are held alternately by the separator 36 with the zigzag shape. In the mode illustrated in FIG. 7, the separator 36 is wound around the outermost periphery of the zigzag structure, thereby forming an outer peripheral surface (outer surface) of the electrode assembly 30. In this embodiment, the separator 36 is wound once or more around the electrode that is disposed on the outermost side in the electrode assembly 30 (in this embodiment, the negative electrode 34 (see FIG. 7)). To a terminal end part 36e of the separator 36, a tape 39 is attached so that the winding of the electrode assembly 30 will not be loosened.

The positive electrode 32 may be, for example, a positive electrode sheet in a rectangular sheet shape. In this embodiment, the positive electrode 32 manufactured using the aforementioned manufacturing method is used. In the positive electrode 32, the positive electrode tab 33 is provided. The positive electrode tab 33 is not limited in particular and may be, for example, a metal foil. The positive electrode tab 33 may be a metal foil formed of, for example, gold, silver, aluminum, or an alloy of these. The positive electrode tab 33 may be attached with a part thereof in contact with the positive electrode current collection layer 32b, for example.

The negative electrode 34 may be, for example, a negative electrode sheet in a rectangular sheet shape. In this embodiment, the negative electrode 34 includes a negative electrode current collection foil in a rectangular sheet shape, and a negative electrode active material layer provided on a surface of the negative electrode current collection foil. The negative electrode current collection foil is preferably formed of copper or a copper alloy, for example. In the mode illustrated in FIG. 6, the negative electrode tab 35 is provided at an end part of the negative electrode current collection foil (an end part on an X2 side in the drawing). The negative electrode tab 35 includes an exposed region where the negative electrode current collection foil is exposed, for example. An exposed part of the negative electrode tab 35 is bonded to the negative electrode current collection part 25, for example. The negative electrode active material layer includes, for example, a negative electrode active material. The negative electrode active material is a material capable of reversibly storing and releasing charge carriers, for example. As the negative electrode active material, for example, a material that is used as the negative electrode active material of this kind of energy storage device can be used without particular limitations. The negative electrode active material layer may include a component other than the negative electrode active material (for example, a binder, a thickener, a dispersant, or the like).

As the separator 36, for example, a separator for this kind of energy storage device can be used without particular limitations. The separator 36 may have a single-layer structure, or may have a structure of two or more layers with different characteristics and properties (thickness, porosity, or the like), for example, a three-layer structure. The separator 36 is formed of resin, for example, and preferably formed of polyolefin resin. The polyolefin resin may be polyethylene, polypropylene, or a mixture of these.

As the electrolyte solution, for example, an electrolyte solution for this kind of energy storage device can be used without particular limitations. The electrolyte solution is, for example, a nonaqueous electrolyte solution including a nonaqueous solvent (organic solvent) and a supporting salt. Examples of the nonaqueous solvent include carbonates such as ethylene carbonate, dimethyl carbonate, and ethyl methyl carbonate. Examples of the supporting salt include fluorine-containing lithium salt such as lithium hexafluorophosphate (LiPF₆).

The spacer 40 is a member that is disposed between the case 10 and the electrode assembly 30, for example. In the mode illustrated in FIG. 6, the spacer 40 is disposed between the case 10 and the first end surfaces 30A1 and 30A2 of the electrode assembly 30. As illustrated in FIG. 6, the spacer 40 is disposed between the first sealing plate 10B and the electrode assembly 30 (the first end surface 30A1 on an X1 side) and between the second sealing plate 10C and the electrode assembly 30 (the first end surface 30A2 on the X2 side). Note that the spacer 40 may be formed of, for example, an insulating resin that has been conventionally used for this kind of energy storage device (for example, polyamide resin or the like).

The resin film 50 is, for example, a member that insulates between the case 10 and the electrode assembly 30. As illustrated in FIG. 6, the resin film 50 is disposed so as to surround an outer periphery of the electrode assembly 30. In this embodiment, the resin film 50 has a tubular shape, and accommodates the electrode assembly 30 on the inside. As a resin material of the resin film 50, for example, a resin material that forms the resin film included in this kind of energy storage device may be used. Examples of such a resin material include polyamide resin, polyolefin resin (such as polyethylene or polypropylene), and the like.

The energy storage device 1 is used for a variety of applications; in particular, the energy storage device 1 can be preferably used as a motive power source for a motor (power source for driving) that is mounted on a vehicle such as a passenger car or a truck. The vehicle is not limited to a particular type, and suitable examples thereof include a plug-in hybrid electric vehicle (PHEV), a hybrid electric vehicle (HEV), a battery electric vehicle (BEV), and the like.

The embodiment of art disclosed herein has been described above; however, the aforementioned embodiment is just an example and will not limit the scope of claims. The techniques described in the scope of claims include those in which the aforementioned embodiment is variously modified and changed, for example.

### Second Embodiment

The second slurry may further include a second metal powder, which is different from the first metal powder. The second metal powder has an average particle diameter of 100 nm to 10 μm. Thus, the content ratio of the first metal powder in the second slurry can be reduced. Thus, the manufacturing cost can be reduced and the productivity can be increased. When the entire metal powder is 100 mass %, the content ratio between the first metal powder and the second metal powder in the metal powder contained in the second slurry is, in a mass ratio, preferably the mass ratio of the first metal powder: the mass ratio of the second metal powder=1:99 to 50:50. When the mass ratio of the first metal powder in the metal powder is more than 50 mass %, the effect of reducing the cost is not obtained easily. In contrary, when the mass ratio of the first metal powder in the metal powder is less than 1 mass %, it is difficult to make the second metal powder electronically conductive efficiently. In the observation of a SEM image of the current collection layer in a case where a low-temperature sintering process is performed with the mass ratio of the first metal powder: the mass ratio of the second metal powder=3:97 in the aforementioned mixing ratio, the cross-sectional area derived from the first metal powder is about 1% to 5% of the entire cross-sectional area of the metal powder. The cross-sectional area ratio in the SEM image observation varies because a three-dimensional structure in which the first metal powder is melted and fused between particles of the second metal powder is observed two-dimensionally, that is, in the SEM image; in view of this, by obtaining the average value through the observation of about ten photographs, the variation in cross-sectional area ratio can be suppressed.

From the viewpoint of reducing the content ratio of the first metal powder in the second slurry, the average particle diameter of the second metal powder is preferably 200 nm or more and more preferably 300 nm or more. In contrary, from the viewpoint of suppressing the excess increase of the thickness of the current collection layer and suppressing the reduction of the volume energy density thereby, the average particle diameter of the second metal powder is for example 8 μm or less, preferably 5 μm or less, and more preferably 3 μm or less. Note that, in this specification, the average particle diameter of the second metal powder refers to a particle diameter (D₅₀ diameter) corresponding to the cumulative frequency 50 vol % from the microparticle side with small particle diameter in the particle size distribution based on the volume in accordance with a laser diffraction/scattering method. The measurement of the average particle diameter (D₅₀ diameter) in accordance with a laser diffraction/scattering method can use a commercial measurement device such as the measurement device “SALD-2200” manufactured by Shimadzu Corporation.

The shape of second metal particles included in the second metal powder may be, for example, a spherical shape, a plate-like shape, a columnar shape, a needle-like shape, a flake shape, or the like, and is preferably the flake shape. When the second metal particle has the flake shape, both the conductivity in the thickness direction of the electrode and the conductivity in a surface direction of the electrode can be increased more.

From the viewpoint of achieving the effect of the art disclosed herein more suitably, the first metal powder and the second metal powder are preferably the same kind of metal. The second metal powder may be, for example, the gold powder, the silver powder, or the aluminum powder.

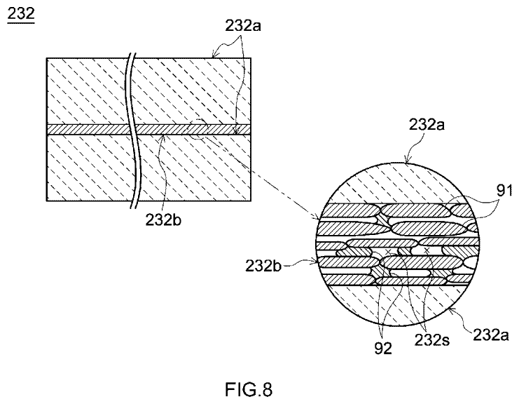

Using the second slurry in this embodiment makes it possible to manufacture a positive electrode 232 illustrated in FIG. 8. FIG. 8 is a cross-sectional view of the positive electrode 232. In FIG. 8, a cross-sectional structure of the positive electrode 232 in the thickness direction is schematically shown. Moreover, a cross-sectional structure of a positive electrode current collection layer 232b is shown in a partially enlarged way in FIG. 8. As illustrated in FIG. 8, the positive electrode 232 includes a positive electrode active material layer 232a, and the positive electrode current collection layer 232b provided on a surface of the positive electrode active material layer 232a. The positive electrode active material layer 232a may be the same as the positive electrode active material layer 32a in the first embodiment.

As illustrated in FIG. 8, the positive electrode current collection layer 232b includes metal particles 91 and metal bond parts 92. The average particle diameter of the metal particles 91 is 100 nm to 10 μm. From the viewpoint of increasing the conductivity of the positive electrode 232 more suitably, the average particle diameter of the metal particles 91 is preferably 200 nm or more and more preferably 300 nm or more. In contrary, from the viewpoint of increasing the energy density of the positive electrode 232 more suitably, the average particle diameter of the metal particles 91 is for example 8 μm or less, preferably 5 μm or less, and more preferably 3 μm or less. Note that the average particle diameter of the metal particles 91 is the average particle diameter based on the electron microscope (SEM) observation image of the cross section along the thickness direction of the positive electrode active material layer 232a. The average particle diameter of the metal particles 91 can be acquired in such a way that, for example, 10 or more metal particles 91 are selected at random in the cross-sectional SEM observation image of the positive electrode active material layer 232a, the equivalent circle diameters thereof are measured, and the average value is calculated. The average particle diameter of the metal particles 91 may be acquired using commercial image analysis software as appropriate.

The metal particles 91 are derived from the second metal powder included in the second slurry here. The shape of the metal particle 91 may be the same as the shape of the second metal particle. In the mode illustrated in FIG. 8, the metal particle 91 has the flake shape. The metal particle 91 is the same metal as the second metal powder here.

The metal bond part 92 bonds the metal particles 91 to each other here. In the mode illustrated in FIG. 8, the metal bond part 92 is a molten metal. The metal bond part 92 is derived from the first metal powder here. In the heat processing step S5 (see FIG. 1), the first metal powder is melted to bond the metal particles 91 (here, the second metal particles) to each other. The metal bond part 92 is the same metal as the first metal powder here.

As illustrated in FIG. 8, the positive electrode current collection layer 232b includes pores 232s. The pore 232s is surrounded by the metal particles 91 and the metal bond parts 92.

As described above, the positive electrode 232 includes the positive electrode active material layer 232a containing the positive electrode active material and the resin binder, and the positive electrode current collection layer 232b provided on the surface of the positive electrode active material layer 232a. The positive electrode current collection layer 232b includes the metal particles 91 and the metal bond parts 92. The metal particles 91 have an average particle diameter of 100 nm to 10 μm. The metal bond parts 92 bond the metal particles 91 to each other.

In other words, in the positive electrode current collection layer 232b of the positive electrode 232, the metal particles 91 are linked to each other through the metal bond parts 92. Thus, the electrical conductivity between the metal particles 91 can be increased more and the decrease in conductivity of the positive electrode 232 can be suppressed.

The metal bond part 92 may be the molten metal. Thus, the contact area between the metal particle 91 and the metal bond part 92 can be increased, making it possible to increase the bondability between the metal particles 91 further. Accordingly, the aforementioned effect can be enhanced more.

The positive electrode current collection layer 232b may include the pores 232s. Thus, the air permeability in the positive electrode current collection layer 232b can be increased. Accordingly, if gas is generated at the manufacture of the positive electrode 232 or at the use of the positive electrode 232, the gas can be discharged more suitably from the positive electrode current collection layer 232b to the outside. As a result, the safety of the energy storage device including the positive electrode 232 can be increased further.

The metal particle 91 may have the flake shape. The metal particles 91 in the flake shape can be aligned along a surface direction of the positive electrode active material layer 232a in the positive electrode current collection layer 232b. Thus, in the positive electrode 232, both the conductivity in the thickness direction and the surface direction of the positive electrode 232 can be increased.

The metal particle 91 and the metal bond part 92 may be the same kind of metal. Thus, the resistance between the metal particle 91 and the metal bond part 92 can be reduced; therefore, the decrease in conductivity of the positive electrode 232 can be suppressed more suitably.

The metal particle 91 and the metal bond part 92 may be formed of gold or silver. Thus, the effect of the art disclosed herein can be achieved more suitably.

The energy storage device 1 may include the positive electrode 232 instead of the positive electrode 32 or in addition to the positive electrode 32. Since the decrease in conductivity is suppressed in the positive electrode 232 as described above, the performance of the energy storage device 1 can be increased further.

### OTHER EMBODIMENTS

The art disclosed herein has been described above using the positive electrode 32 or the positive electrode 232 as the example. However, the art disclosed herein is also applicable to the negative electrode. In this case, the decrease in conductivity of the negative electrode is suppressed. Moreover, since the amount of copper in the negative electrode can be reduced, the weight of the negative electrode can be reduced and furthermore, the size of the energy storage device can be reduced. Note that, in the case of achieving the art disclosed herein in the negative electrode, the first metal powder and the second metal powder may be the gold powder, the silver powder, or a copper powder.

In the embodiment described above, the electrode assembly 30 with the zigzag structure has been described. However, the art disclosed herein is not limited to this. The electrode assembly 30 may be replaced by a multilayer electrode assembly. In the multilayer electrode assembly, for example, the positive electrode 32 or the positive electrode 232 in the rectangular sheet shape and the negative electrode 34 in the rectangular sheet shape are stacked with the separator in the rectangular sheet shape held therebetween.

The art disclosed herein can include the techniques according to the following items.
Item 1: The manufacturing method for the electrode including the electrode active material layer containing the electrode active material and the resin binder, and the current collection layer provided on the surface of the electrode active material layer, the manufacturing method including:
   providing the electrode active material layer on the surface of the base material;
   applying the slurry including the first metal powder with an average particle diameter of less than 100 nm based on the dynamic light scattering method on the surface of the electrode active material layer provided on the base material; and
   performing the heat processing on the electrode active material layer and the slurry applied on the surface of the electrode active material layer at the temperature lower than the thermal decomposition temperature of the resin binder, thereby providing the current collection layer on the surface of the electrode active material layer.
Item 2: The manufacturing method according to Item 1, in which the temperature of the heat processing is 200° C. or less.
Item 3: The manufacturing method according to Item 1 or 2, in which the resin binder includes PVdF.
Item 4: The manufacturing method according to any one of Items 1 to 3, in which in the applying of the slurry, the slurry is applied in the mesh shape on the surface of the electrode active material layer.
Item 5: The manufacturing method according to any one of Items 1 to 4, in which the slurry further includes the second metal powder with an average particle diameter of 100 nm to 10 μm based on the laser diffraction/scattering method.
Item 6: The manufacturing method according to any one of Items 1 to 5, in which the current collection layer includes pores.
Item 7: The manufacturing method according to any one of Items 1 to 5, in which the second metal powder includes the second metal particles in the flake shape.
Item 8: The manufacturing method according to any one of Items 1 to 7, in which the first metal powder and the second metal powder include the same kind of metal.
Item 9: The manufacturing method according to any one of Items 1 to 8, in which the electrode is the positive electrode.
Item 10: The manufacturing method according to any one of Items 1 to 9, in which the first metal powder is the gold powder or the silver powder.
Item 11: The manufacturing method for the energy storage device including the electrode, including manufacturing the electrode using the manufacturing method according to any one of Items 1 to 10.
Item 12: The electrode including the electrode active material layer containing the electrode active material and the resin binder, and the current collection layer provided on the surface of the electrode active material layer, in which the current collection layer includes the metal particles with an average particle diameter of 100 nm to 10 μm based on the electron microscope observation image of the cross section along the thickness direction of the electrode active material layer, and the metal bond part connecting between the metal particles.
Item 13: The electrode according to Item 12, in which the metal bond part is the molten metal.
Item 14: The electrode according to Item 12 or 13, in which the current collection layer includes pores.
Item 15: The electrode according to any one of Items 12 to 14, in which the metal particles are in a flake shape.
Item 16: The electrode according to any one of Items 12 to 15, in which the metal particles and the metal bond part include the same kind of metal.
Item 17: The electrode according to any one of Items 12 to 16, in which the current collection layer has the mesh shape in the plan view.
Item 18: The electrode according to any one of Items 12 to 17, in which the electrode is the positive electrode.
Item 19: The electrode according to any one of Items 12 to 18, in which the metal particles and the metal bond part are formed of gold or silver.
Item 20: The energy storage device including the electrode according to any one of Items 12 to 19.

What is claimed is:

1. A manufacturing method for an electrode including an electrode active material layer containing an electrode active material and a resin binder, and a current collection layer provided on a surface of the electrode active material layer, the manufacturing method comprising:
providing the electrode active material layer on a surface of a base material;
applying a slurry including a first metal powder with an average particle diameter of less than 100 nm based on a dynamic light scattering method on the surface of the electrode active material layer provided on the base material; and
performing heat processing on the electrode active material layer and the slurry applied on the surface of the electrode active material layer at a temperature lower than a thermal decomposition temperature of the resin binder, thereby providing the current collection layer on the surface of the electrode active material layer.

2. The manufacturing method according to claim 1, wherein
the temperature of the heat processing is 200° C. or less.

3. The manufacturing method according to claim 2, wherein
the resin binder includes PVdF.

4. The manufacturing method according to claim 1, wherein
in the applying of the slurry, the slurry is applied in a mesh shape on the surface of the electrode active material layer.

5. The manufacturing method according to claim 1, wherein
the slurry further includes a second metal powder with an average particle diameter of 100 nm to 10 μm based on a laser diffraction/scattering method.

6. The manufacturing method according to claim 5, wherein
the current collection layer includes pores.

7. The manufacturing method according to claim 5, wherein
the second metal powder includes second metal particles in a flake shape.

8. The manufacturing method according to claim 5, wherein
the first metal powder and the second metal powder include the same kind of metal.

9. The manufacturing method according to claim 1, wherein
the electrode is a positive electrode.

10. The manufacturing method according to claim 9, wherein
the first metal powder is a gold powder or a silver powder.

11. An electrode comprising:
an electrode active material layer containing an electrode active material and a resin binder; and
a current collection layer provided on a surface of the electrode active material layer, wherein
the current collection layer includes metal particles with an average particle diameter of 100 nm to 10 μm based on an electron microscope observation image of a cross section along a thickness direction of the electrode active material layer, and a metal bond part connecting between the metal particles.

12. The electrode according to claim 11, wherein
the metal bond part is a molten metal.

13. The electrode according to claim 11, wherein
the current collection layer includes pores.

14. The electrode according to claim 11, wherein
the metal particles are in a flake shape.

15. The electrode according to claim 11, wherein
the metal particles and the metal bond part include the same kind of metal.

16. The electrode according to claim 11, wherein
the current collection layer has a mesh shape in a plan view.

17. The electrode according to claim 11, wherein
the electrode is a positive electrode.

18. The electrode according to claim 17, wherein
the metal particles and the metal bond part are formed of gold or silver.

19. An energy storage device comprising
the electrode according to claim 11.
